(19) United States
(12) Patent Application Publication
(10) Pub. No.: US 2013/0135850 A1
(43) Pub. Date: May 30, 2013

(54) Lamp Board Wiring Structure for Light Emitting Diode (LED) Lamp Tube

(71) Applicants: Ruei-Jhih JHENG, Jhubei City (TW); Fu-Ching Ke, Jhubei City (TW); Yi-Chang Chung, Jhubei City (TW)

(72) Inventors: Ruei-Jhih JHENG, Jhubei City (TW); Fu-Ching Ke, Jhubei City (TW); Yi-Chang Chung, Jhubei City (TW)

(21) Appl. No.: 13/591,618

(22) Filed: Aug. 22, 2012

(30) Foreign Application Priority Data
Nov. 28, 2011 (TW) 100222477

(51) Int. Cl. F21V 1/00

(52) U.S. Cl. 362/217.02

(57) ABSTRACT

An improved lamp board wiring structure for light emitting diode (LED) lamp tube, wherein the LED lamp tube comprises a lampshade, at least an LED lamp strap installed inside the lampshade, and at least a left side drive circuit structure and a right side drive circuit structure installed inside the lampshade. The left side drive circuit structure and the right side drive circuit structure are respectively positioned on the left and right side of the LED lamp strap. Also, at least a transmission line connecting the left side and the right side drive circuit structures is provided on any side of the lamp board part in the LED lamp strap such that the left side drive circuit structure and the right side drive circuit structure commonly drive the same LED lamp strap.

The current application claims a foreign priority to the patent application of Taiwan No. 100222477 filed on Nov. 28, 2011.

### BACKGROUND OF THE INVENTION

1. Field of the Invention

The present invention generally relates to an improved lamp board wiring structure for light emitting diode (LED) lamp tube; in particular, the present invention relates to an improved lamp board wiring structure capable of using the left side and the right side drive circuit structures to commonly drive an LED lamp strap.

2. Description of Related Art

Featuring many advantages such as better power saving, longer life span, smaller size and faster reaction speed or the like, light emitting diodes (LEDs) are at present comprehensively applied in various illumination fields. Now certain manufacturers have developed the LED lamp tube allowable for replacement of fluorescent lamps. A conventional LED lamp tube is installed with two LED lamp straps inside the long-strapped lampshade, and a drive circuit structure connected with the LED lamp strap is respectively installed on the two sides of the interior of the long-strapped lampshade in order to drive the LED lamp strap to illuminate with the two ends.

In addition to the two-ended drive structure as described above, there are also companies developing a type of single-ended drive structure for LED lamp strap illumination. To further reduce the tube diameter of the long-strapped lampshade for minimization and cost savings, some manufacturers tried to divide the drive circuit structure 12 applied in the LED lamp tube 1 into two blocks and place them individually on the left and right sides of the interior of the long-strapped lampshade 11. However, since the drive circuit structures 121, 122 thus divided need to be connected so as to drive the LED lamp strap 13 of the LED lamp 131, as shown in FIGS. 1 and 2, at least a transmission line 14 has to be linked between these two divided drive circuit structures 121 and 122, in which the transmission line 14 has to cross over the top of the LED lamp strap 13 thus connecting the two divided drive circuit structures 121, 122. Since the space occupied by these two divided drive circuit structures 121, 122 in the long-strapped lampshade 11 is also reduced, the tube diameter of the in the long-strapped lampshade 11 can be less accordingly.

Although the aforementioned structure can successfully decrease the tube diameter of the in the long-strapped lampshade 11, the transmission line 14 must cross over the top of the LED lamp strap 13, so that, during signal transmissions, EMI (electro-magnetic interference) may easily occur, leading to adverse impact or lower operation performance in the drive circuit structures 121, 122 or the LED lamp strap 13. In addition to the EMI factor, the cross-over transmission line 14 also requires sufficient space to achieve the connection between the divided drive circuit structures 121, 122. Hence, it can be appreciated that the effective range of tube diameter reduction in the long-strapped lampshade can be only limited, otherwise the accommodation space for the transmission line 14 would be squeezed. Therefore, the original intention for lowered manufacture costs by means of minimization may not be well achieved.

As a result, it would be an optimal solution if the transmission line can be wired in attachment to the LED lamp strap in order to prevent the occurrence of EMI caused by cross-over wires and excessive occupation in the accommodation space thereby successfully reaching the purpose of lamp tube minimization.

### SUMMARY OF THE INVENTION

The present invention provides a lamp board wiring structure capable of allowing the left and right side drive circuit structures to commonly drive an LED lamp strap thereby effectively reducing the tube diameter of the lampshade.

An improved lamp board wiring structure for light emitting diode (LED) lamp tube according to the present invention can achieve the aforementioned innovative objective, wherein the LED lamp tube comprises a lampshade, at least an LED lamp strap installed inside the lampshade, and at least a left side drive circuit structure and a right side drive circuit structure installed inside the lampshade, in which the left side drive circuit structure and the right side drive circuit structure are respectively positioned on the left and right side of the LED lamp strap, and at least a transmission line connecting the left side and the right side drive circuit structures is provided on any side of the lamp board part in the LED lamp strap such that the left side drive circuit structure and the right side drive circuit structure commonly drive the same LED lamp strap, in which such a structure capable of commonly driving an LED lamp strap by means of the two-ended drive circuit structure can effectively reduce the tube diameter of the lampshade as well.

More specifically, the aforementioned LED lamp strap includes a plurality of LEDs.

More specifically, the aforementioned lampshade is of a long-strapped shape.

More specifically, the aforementioned left side drive circuit structure and right side drive circuit structure can be connected through a transmission line to form a complete drive circuit structure, and the left side and right side drive circuit structures can be further connected to the LED lamp strap so as to drive the LED lamp strap to illuminate with the two ends.

### BRIEF DESCRIPTION OF THE DRAWINGS

FIG. 1 shows a structural diagram of a prior art LED lamp tube;

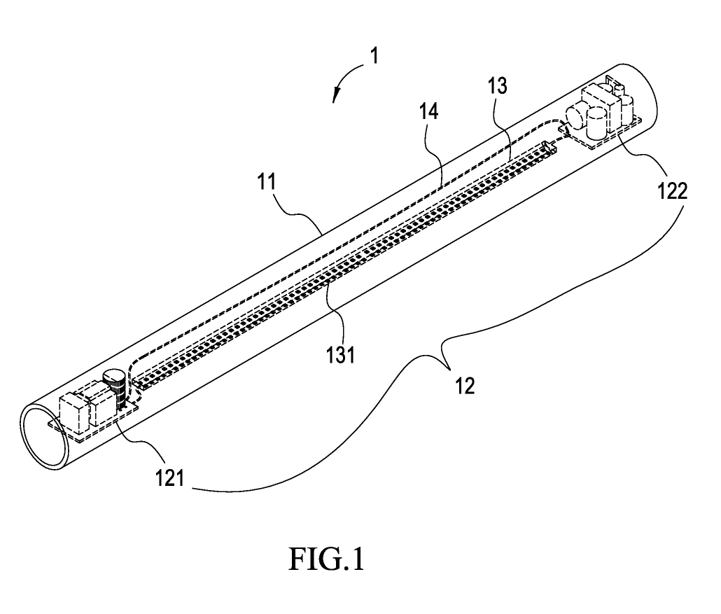

FIG. 2 shows a structural side view of a prior art LED lamp tube;

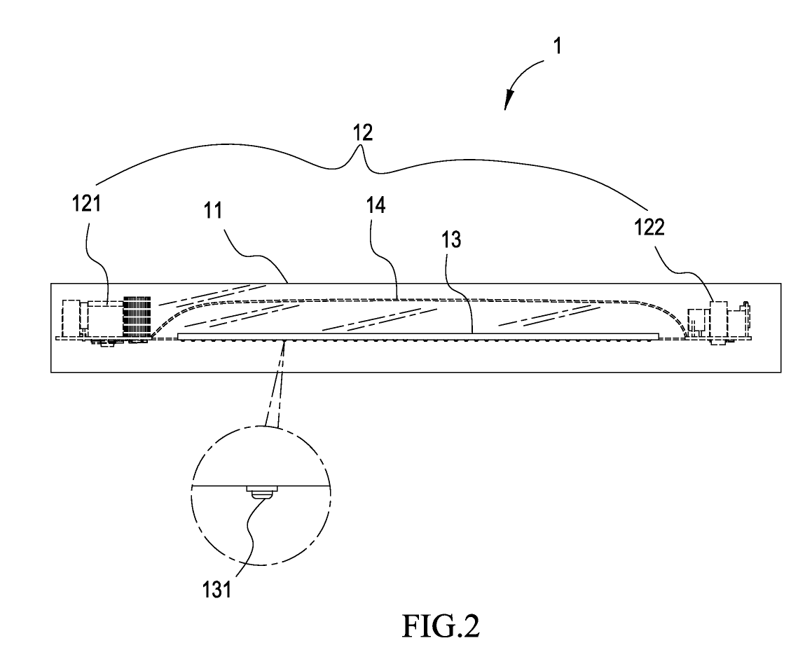

FIG. 3 shows a structural diagram of an improved lamp board wiring structure for LED lamp tube according to the present invention; and

FIG. 4 shows a structural side view of an improved lamp board wiring structure for LED lamp tube according to the present invention.

### DETAILED DESCRIPTION OF THE PREFERRED EMBODIMENTS

The aforementioned and other technical contents, aspects and effects in relation with the present invention can be clearly appreciated through the detailed descriptions concerning the preferred embodiments of the present invention in conjunction with the appended drawings.

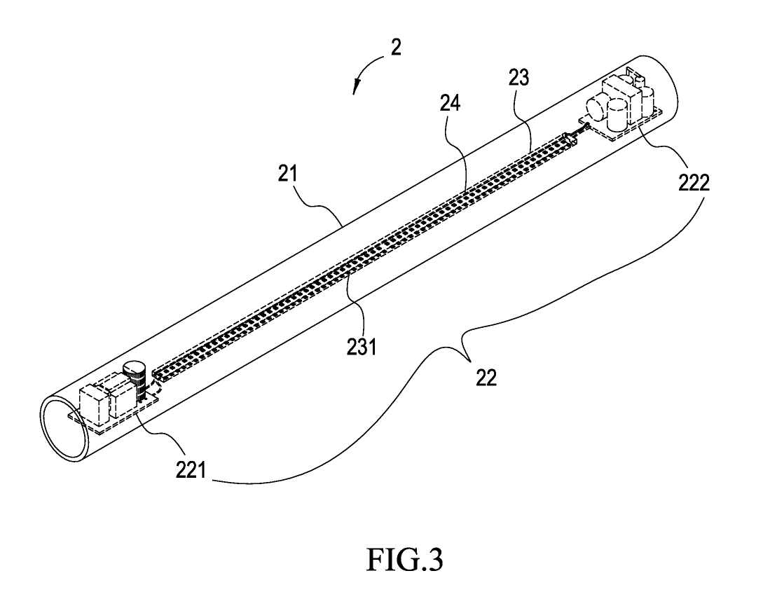

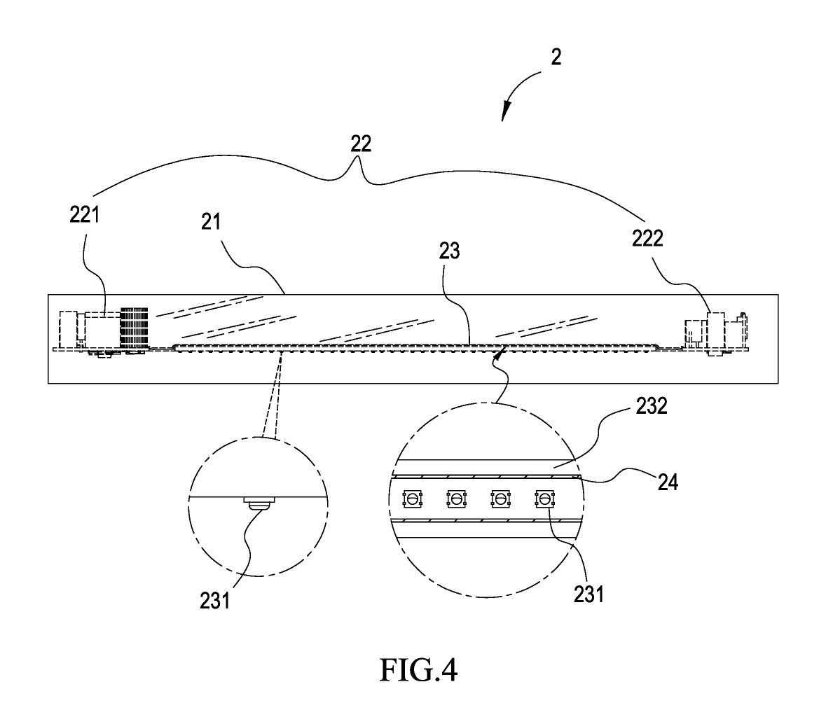

Refer first to FIGS. 3 and 4, wherein a structural diagram and a side view of an improved lamp board wiring structure for LED lamp tube according to the present invention are shown. It can be seen from the Figures that, inside the lampshade 21 of the LED lamp tube 2, at least an LED lamp strap 23, a left side drive circuit structure 221 and a right side drive circuit structure 222 are installed inside the lampshade 21, wherein the left side drive circuit structure 221 and the right side drive circuit structure 222 are respectively positioned on the left side and right side of the LED lamp strap 23 having a plurality of LEDs. Therefore, after installations inside the lampshade 21, since the left side drive circuit structure 221 and the right side drive circuit structure 222 in design are formed by dividing a complete drive circuit structure 22, the left side drive circuit structure 221 and the right side drive circuit structure 222 need to be connected by way of a transmission line 24 in order to constitute a complete drive circuit structure 22.

Herein the transmission line 24 is distributed on a lamp board part 232 of the LED lamp strap 23 and can be configured on any side of the lamp board part 232 to enable the connection between the left side drive circuit structure 221 and the right side drive circuit structure 222; hence, upon connecting the left side drive circuit structure 221 and the right side drive circuit structure 222 to the LED lamp strap, the complete drive circuit structure 22 can provide the electric power for the illumination of the LED lamp strap 23 and allow the two ends of the drive circuit structures 221, 222 to drive the LED lamp strap 23 for light emissions.

Moreover, for the transmission line 24 installed on the lamp board part 232, it is possible to take a printed circuit board (PCB) rinsing approach to print the transmission line 24 onto any side of the lamp board part 232, thus that, when the left side drive circuit structure 221 and the right side drive circuit structure 222 are respectively connected to one end and the other end of the transmission line 24 and the circuit in the transmission line 24 connects the left side drive circuit structure 221 and the right side drive circuit structure 222 with each other, a complete drive circuit structure 22 can be successfully formed.

Besides, since the left side drive circuit structure 221 and the right side drive circuit structure 222 are obtained by dividing a complete drive circuit structure 22, as previously described, the space occupied by the left side drive circuit structure 221 and the right side drive circuit structure 222 can be reduced; in addition, the left side drive circuit structure 221 and the right side drive circuit structure 222 can be connected through the transmission line 24 without crossing over the LED lamp strap 23, so the tube diameter of the lampshade 21 can be lessened and unnecessary costs can be accordingly saved.

Compared with other conventional technologies, the improved lamp board wiring structure for LED lamp tube provided by the present invention further offers the following advantages:

1. The present invention uses a left side and a right side drive circuit structures to commonly drive an LED lamp strap and applies a transmission line wired in attachment to the LED lamp strap to connect the left and right side drive circuit structures thereby achieving the objective of lamp tube minimization.

2. The lamp board wiring structure according to the present invention prevents the EMI caused by the cross-over wires and also saves the increased accommodation space for receiving the cross-over wires, so the manufacture costs for the LED lamp tube can be reduced as well.

By way of the aforementioned detailed descriptions for the preferred embodiments according to the present invention, it is intended to better illustrate the characters and spirit of the present invention rather than restricting the scope of the present invention to the preferred embodiments disclosed in the previous texts. Contrarily, the objective is to encompass all changes and effectively equivalent arrangements within the scope of the present invention as delineated in the following claims of the present application.

What is claimed is:

1. An improved lamp board wiring structure for light emitting diode (LED) lamp tube, wherein the LED lamp tube comprises a lampshade, at least an LED lamp strap installed inside the lampshade, and at least a left side drive circuit structure and at least a right side drive circuit structure installed inside the lampshade, characterized in that: the left side drive circuit structure and the right side drive circuit structure are respectively positioned on the left and right side of the LED lamp strap, and at least a transmission line connecting the left side and the right side drive circuit structures is provided on any side of the lamp board part in the LED lamp strap such that the left side drive circuit structure and the right side drive circuit structure commonly drive the same LED lamp strap.

2. The improved lamp board wiring structure for LED lamp tube according to claim 1, wherein the LED lamp strap includes a plurality of LEDs.

3. The improved lamp board wiring structure for LED lamp tube according to claim 1, wherein the lampshade is of a long-strapped shape.

4. The improved lamp board wiring structure for LED lamp tube according to claim 1, wherein the left side drive circuit structure and right side drive circuit structure are connected through a transmission line to form a complete drive circuit structure, and the left side and right side drive circuit structures is further connected to the LED lamp strap so as to drive the LED lamp strap to illuminate with the two ends.
